(19) United States
(12) Patent Application Publication
(10) Pub. No.: US 2009/0049063 A1
(43) Pub. Date: Feb. 19, 2009

(54) METHOD FOR ENABLING A COMPANY TO MANAGE THE EXECUTION OF A TASK

(76) Inventor: Anthony Lacopo, Laval (CA)

Correspondence Address: FASKEN MARTINEAU DUMOULIN, LLP, STOCK EXCHANGE TOWER, SUITE 3400, P.O. BOX 242, 800 PLACE VICTORIA, MONTREAL, QC, H4Z 1E9, CA

(21) Appl. No.: 11/839,602

(22) Filed: Aug. 16, 2007

(51) Int. Cl. G06F 17/30

(52) U.S. Cl. 707/100; 707/E17.001

(57) ABSTRACT

A method for enabling a company to manage the execution of a task, the method comprising identifying information pertinent to the execution of the task, generating a list of requests related to the identified information, collecting data pertinent to the execution of the task using the generated list of requests, populating a database using the collected data and providing an interface to the company for accessing the database while the database is being populated to thereby timely manage the execution of the task.

### FIELD OF THE INVENTION

The invention relates to computer programs. More precisely, this invention relates to a system and method for enabling a company to manage the execution of a task.

### BACKGROUND OF THE INVENTION

It is key for an entity to timely manage the execution of a task especially if the entity is not performing the task itself such as when the task is outsourced to a third party for instance.

Failure to properly manage a task can cause great prejudice to a company.

The skilled addressee will appreciate that the management of a task can be quite cumbersome for the company. This is especially true in the case where the company is large and furthermore when the company use largely outsourcing. Moreover this issue becomes critical in the case where customers are served by a third party.

For instance, in the case of a telecommunication company, such as a cable company, most if not all installation or repair tasks are outsourced to third parties which are companies specialized in installations or repairs. In such situations, it becomes very difficult if not impossible to timely control and manage the execution of the tasks performed by the third parties at the client premises.

While in some instances, some third parties may deliver borderline services to the customers of the telecommunication company, in some other instances, some employees of the third party to which the task is outsourced may even conduct or promote criminal activities which may cause prejudice to the telecommunications company.

There is a need for a method and apparatus that will overcome at least one of the above-identified drawbacks.

Features of the invention will be apparent from review of the disclosure, drawings and description of the invention below.

### BRIEF SUMMARY OF THE INVENTION

The invention provides a method for enabling a company to manage the execution of a task, the method comprising identifying information pertinent to the execution of the task, generating a list of requests related to the identified information, collecting data pertinent to the execution of the task using the generated list of requests, populating a database using the collected data and the company accessing the database while the database is being populated using an interface to thereby timely manage the execution of the task.

Since the company is capable to access the database while it is being populated, the method disclosed enables the company to timely manage the execution of the task.

The invention further provides a method for enabling a company to manage the execution of a task, the method comprising identifying information pertinent to the execution of the task, generating a list of requests related to the identified information, collecting data pertinent to the execution of the task using the generated list of requests, populating a database using the collected data and providing an interface to the company for accessing the database while the database is being populated to thereby timely manage the execution of the task.

According to another aspect of the invention, there is provided a method of doing business wherein a third party enables a company to manage the execution of a task, the method comprising identifying information pertinent to the execution of the task, generating a list of requests related to the identified information, the third party collecting data pertinent to the execution of the task using the generated list of requests, populating a database using the collected data and the third party providing an interface to the company for a fee for accessing the database while the database is being populated to thereby timely manage the execution of the task.

### BRIEF DESCRIPTION OF THE DRAWINGS

In order that the invention may be readily understood, embodiments of the invention are illustrated by way of example in the accompanying drawings.

FIG. 1 is a block diagram which shows an embodiment where a system for enabling a task managing unit to manage the execution of a task is advantageously used.

FIG. 2 is a block diagram which shows another embodiment of a system where the system for enabling a task managing unit to manage the execution of a task is advantageously used.

FIG. 3 is a flowchart which shows one embodiment for enabling a company to manage the execution of a task; according to a first step, information pertinent to the execution of a task is identified; according to a second step, a list of requests related to the identified information is generated; according to a third step, data pertinent to the execution of the task is collected; according to a fourth step, the database is populated using the collected data and according to a fifth step, the database is accessed.

FIG. 4 is a flowchart which shows one embodiment for identifying information pertinent to the execution of a task; a list of a plurality of parties interacting with the agent is provided together with a list of a plurality of tasks performed by each of the parties interacting with an agent and both lists are uploaded to the database.

FIG. 5 is a flowchart which shows one embodiment for generating a list of requests related to the identified information; according to a first step pertinent information data is selected in the list, according to a second step, a list of requests is generated using the selected pertinent data and according to a third step, a survey is generated using the generated list of requests.

FIG. 6 is a flowchart which shows one embodiment for collecting data pertinent to the execution of the task; according to a first step, a survey is opened, according to a second step, the party interacting with the agent is contacted and according to a third step the survey is completed using information provided by the contacted party.

FIG. 7 is a flowchart which shows one embodiment for accessing the database; according to a first step, the task managing unit is logging into the database, according to a second step, the task managing unit is sending a request for pertinent information and according to a third step, the task managing unit is accessing the pertinent information.

Further details of the invention and its advantages will be apparent from the detailed description included below.

### DETAILED DESCRIPTION OF PREFERRED EMBODIMENTS

In the following description of the embodiments, references to the accompanying drawings are by way of illustration of an example by which the invention may be practiced. It will be understood that other embodiments may be made without departing from the scope of the invention disclosed.

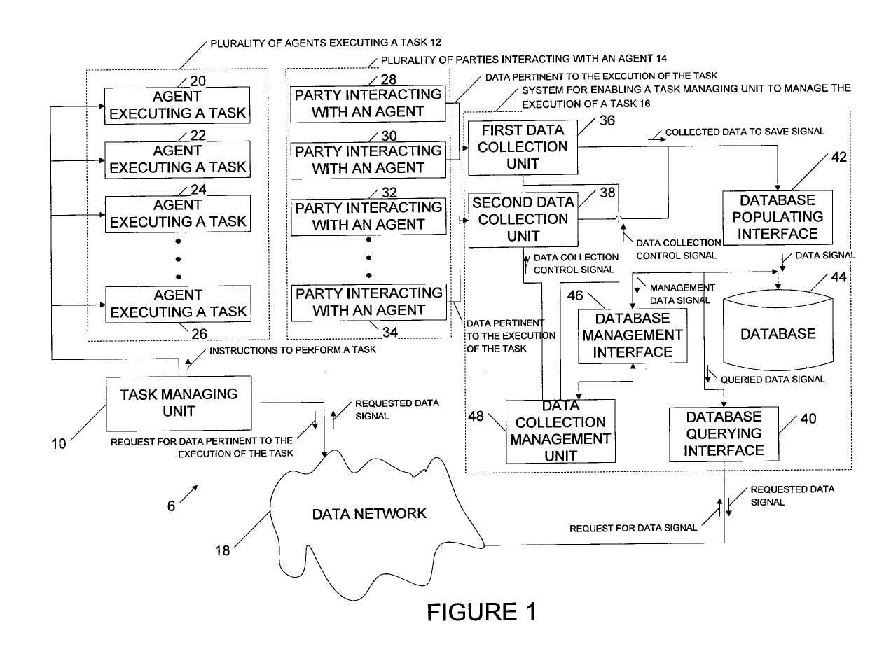

Now referring to FIG. 1, the system 6 comprises a task managing unit 10, a plurality of agents executing a task 12, a plurality of parties interacting with an agent 14, a system for enabling a task managing unit to manage the execution of a task 16 and a data network 18.

The task managing unit 10 is providing instructions to perform a task to the plurality of agents executing a task. The task managing unit 10 may comprise an individual, a plurality of individuals, a company, a plurality of companies, a non-profit organization, a government, an automated system or the like.

In the embodiment disclosed in FIG. 1, the plurality of agents executing a task 12 comprises a first agent executing a task 20, a second agent executing a task 22, a third agent executing a task 24 and a fourth agent executing a task 26. Each agent of the plurality of agents is executing a task in accordance with instructions provided by the task managing unit 10. The task may be related or not to tangible items or goods. For instance, the task may be related to at least one of buying, selling and brokering a good or an item. Alternatively, the task may be related to the providing of a service. Moreover, it will be appreciated by the skilled addressee that the plurality of agents executing a task 12 may or may not execute the task in the vicinity of the task managing unit 10. Accordingly, it should be understood that the instructions to perform a task may be provided to the plurality of agents executing a task 12 using various means such as email, facsimile, SMS messages, e-tickets, work orders, transmission to mobile devices, automated systems, voice instructions or the like.

The plurality of parties interacting with an agent 14 comprises a first party interacting with an agent 28, a second party interacting with an agent 30, a third party interacting with an agent 32 and a fourth party interacting with an agent 34.

It will be appreciated that a party interacting with an agent may be selected from a group consisting of employees, clients or customers, potential clients, potential customers, individuals, companies, government, non-profit organizations, partners, suppliers or the like.

Still referring to FIG. 1, the system for enabling a task managing unit to manage the execution of a task 16 comprises a first data collection unit 36, a second data collection unit 38, a database querying interface 40, a database populating interface 42, a database 44, a database management interface 46, a data collection management unit 48.

The first data collection unit 36 and a second data collection unit 38 are used to collect data pertinent to the execution of the task from at least one of the plurality of parties interacting with an agent 14. While it has been disclosed an embodiment with two data collection units, the skilled addressee will appreciate that any number of data collection unit may be used in the system for enabling a task managing unit to manage the execution of a task 16.

In one embodiment, the data collection unit comprises a processing device such as a computer and/or a telephone. Alternatively, the skilled addressee will appreciate that the data collection unit depends on the type of data pertinent to the execution of the task.

In the embodiment disclosed in FIG. 1, each of the first data collection unit 36 and the second data collection unit 38 is operating using the data collection management unit 48.

The data collection management unit 48 is provided to ensure that an adequate data collection is achieved. In one embodiment, the data collection management unit 48 comprises a processing device such as a computer.

More precisely and as shown in FIG. 1, a respective collected data to save signal is provided by each of the first data collection unit 36 and the second data collection unit 38 to a database populating interface 42. The database populating interface 42 is used by the first data collection unit 36 and the second data collection unit 38 to save data in the database 44. In one embodiment, the database populating interface 42 is provided using an interface programmed with PhP. Alternatively, it will be appreciated by the skilled addressee that the database populating interface 42 may be provided using any other programming languages such as .NET, JAVA, C, C++, etc.

As shown in FIG. 1, the data collection management unit 48 provides a data collection control signal to the first data collection unit 36 and to the second data collection unit 38. The data collection control signal is indicative of data to collect as further explained below.

The data collection management unit 48 is operatively connected to the database 44 via a database management interface 46. The data collection management unit 48 is receiving specific data from the database 44. More precisely, the data collection management unit 48 receives a data signal from the database management interface 46 which collects in return a management data signal from the database 44. It will be appreciated that the data signal received by the data collection management unit 48 may comprise for instance data representative of the operating of a data collection unit. For instance, in the case where the data collection unit is a call center agent, the data may comprise a number of calls performed per hour, a number of surveys completed per hour, the amount of working time, the average length and success rate of a call, etc.

The database 44 is used to store data pertinent to the execution of a task as further explained below. The skilled addressee will appreciate that the database 44 may be accessed by the task managing unit 10 as further explained below. In one embodiment, the database is a MySQL database. Alternatively, it will be appreciated by the skilled addressee that the database 44 may be an MS SQL database, an Oracle database, an Access database or the like.

The task managing unit 10 performs a request for data pertinent to the execution of a task to the system for enabling a task managing unit to manage the execution of a task 16. More precisely, the task managing unit 10 sends a request for data pertinent to the execution of the task to the database querying interface 40 of the system for enabling a task managing unit to manage the execution of a task 16. The request for data pertinent to the execution of the task is performed using the database querying interface 40. It will be appreciated that the request may pertain to at least one of a specific task, a specific agent performing a task and a specific party interacting with an agent or the like.

In response to the request for data signal provided to the data querying interface 40, a queried data signal is provided by the database 44 back to the database querying interface 40 which in turns provides a requested data signal to the task managing unit 10. The skilled addressee will appreciate that the requested data signal depends on various factors. The requested data signal may comprise performance indicators related to the task or the like. It will be appreciated that the task managing unit 10 is operatively connected to the system for enabling a task managing unit to manage the execution of a task 16 via the data network 18. The data network 18 may be at least one of a local area network (LAN), a metropolitan area network (MAN), a wide area network (WAN) and a dedicated point to point connection. Moreover, the connection to the data network 18 may be performed using a wire connection as well as a wireless connection (e.g. using anyone of CDMA, GSM, WiFi, WiMAX, Microwave link, or the like). In one embodiment, the data network 18 comprises the Internet.

It will be appreciated by the skilled addressee that the first data collection unit 36 and to the second data collection unit 38 may or may not be located in the vicinity of the database 44, the database populating interface 42, the database management interface 46 and the data collection management unit 48.

Similarly, it should be understood by the skilled addressee that the system for enabling a task managing unit to manage the execution of a task 16 may or may not located in the vicinity of the task managing unit 10.

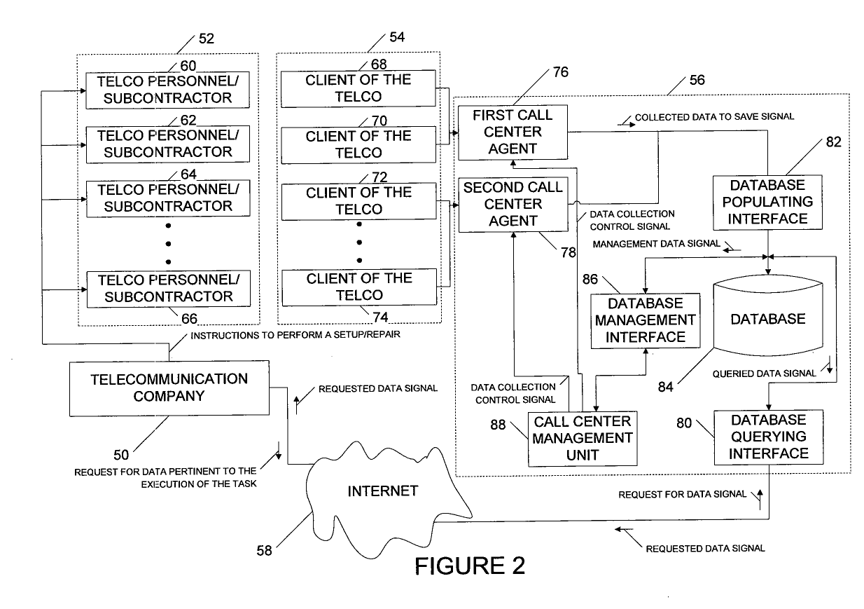

Now referring to FIG. 2, there is shown one embodiment where the system for enabling a task managing unit to manage the execution of a task 16 is advantageously used.

In this embodiment, the task managing unit 10 is a telecommunication company 50. Still in the embodiment disclosed, the system comprises a plurality of telecommunication company personnel and/or subcontractors 52 for serving a plurality of clients of the telecommunication company 54. The system further comprises a system for enabling the telecommunication company to manage the execution of a task 56 and a data network 58.

More precisely, the plurality of telecommunication company personnel/subcontractor 52 comprises a first telecommunication company personnel/subcontractor 60, a second telecommunication company personnel/subcontractor 62, a third telecommunication company personnel/subcontractor 64 and a fourth telecommunication company personnel/subcontractor 66. The telecommunication company 50 provides instructions to perform a setup or a repair to each of the plurality of telecommunication company personnel and or subcontractors 52. For instance, the instructions relates to setting up a new cable connection or repairing an existing cable connection in the case where the telecommunication company provides a cable services to its customers.

The plurality of clients of the telecommunication company 54 comprises in this embodiment a first client of the telecommunication company 68, a second client of the telecommunication company 70, a third client of the telecommunication company 72 and a fourth client of the telecommunication company 74. It will be appreciated by the skilled addressee that the setting up of a cable connection or the repairing of an existing cable connection is performed at a client's premise by at least one of the plurality of telecommunication company personnel/subcontractors.

The system for enabling the telecommunication company to manage the execution of a task 56 comprises in this embodiment a first call center agent 76 and a second call center agent 78. Each of the first call center agent 76 and the second call center agent 78 may access a database 84 using a database populating interface 82. More precisely, and depending on the interaction with each of the clients of the telecommunication company, each of the first call center agent 76 and the second call center agent 78 is providing collected data to save signal to the database 84 using the database populating interface 82.

A call center management unit 88 is used to provide a data collection control signal to each of the first call center agent 76 and the second call center agent 78. The data collection control signal provided by the call center management unit 88 is provided based on a management data signal received from the database 84 via a database management interface 86. The skilled addressee will therefore appreciate that the first call center agent 76 and the second call center agent 78 are preferably operating in accordance with the data collection control signal.

A database querying interface 80 is provided to the telecommunication company 50 for accessing the database 84. More precisely, the telecommunication company 50 provides a request for data pertinent to the execution of a task by one of the plurality of telecommunication company personnel/subcontractors 52 to the database querying interface 80 and receives in response a requested data signal via a data network 58 which is in a preferred embodiment the Internet. The skilled addressee will appreciate that in this embodiment the communication can be encrypted using a virtual private network (VPN) and/or a HTTPS encryption scheme. Alternatively, the communication is not encrypted in the case where a dedicated connection (i.e. a private connection) is used between the telecommunication company 50 and the database querying interface 80.

The skilled addressee will appreciate that this is of great advantage since it enables the telecommunication company to overview the execution of tasks performed by the personnel or subcontractor of the telecommunication company which is of great advantage especially in the latter case.

In a preferred embodiment, the system for enabling the telecommunication company to manage the execution of a task 56 is implemented by a third party. Still in this preferred embodiment, the telecommunication company 50 is billed for the service. It will be appreciated that the telecommunication company 50 may be billed according to various plans such as a fixed fee scheme, a variable fee scheme or the like. Moreover, a fee may be based on an amount of access to the database 84, a fee may be based on the type of data accessed in the database 84 or the like. Alternatively, the telecommunication company 50 may also be billed according to a number of hours worked by the data collection unit.

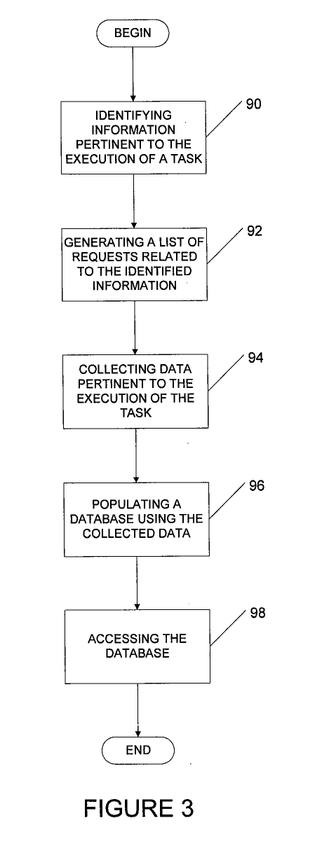

Now referring to FIG. 3, there is shown one embodiment of the method for enabling a task managing unit to manage the execution of a task.

According to step 90, information pertinent to the execution of a task is identified. In one embodiment, the information pertinent to the execution is identified by the task managing unit 10. Alternatively, the information pertinent to the execution is identified by the system for enabling a task managing unit to manage the execution of a task 16; in such embodiment; the information pertinent to the execution of a task may be identified by the data collection management unit 48 for instance.

It will be appreciated that the information pertinent to the execution may be identified using various means such as for instance by entering data, selecting data in a menu or the like.

According to step 92 a list of requests related to the identified information is generated. The list of requests is generated using the database.

In one embodiment, the list of requests is generated in an event-triggered fashion, such as after an update of the database. Alternatively, the list of requests is generated periodically at specific time. Still in one embodiment, the list of requests is generated by the data collection management unit 48 using the database. The data collection management unit 48 may generate for instance a list of requests based on various criteria. For instance, the data collection management unit 48 may select the list of requests based only on the data provided to the database. This may be used for instance to amend a data collecting strategy. Alternatively, the list of requests may be generated based on a service package ordered by the task managing unit 10. Alternatively, the lists of requests may be generated based on or following an analysis of the data provided to the database, such as for instance when specific data are unacceptable for the task managing unit 10.

According to step 94, data pertinent to the execution of the task is collected. The data pertinent to the execution of the task is collected from the plurality of parties interacting with an agent 14 using a data collection unit.

It will be appreciated by the skilled addressee that the data pertinent to the execution of the task may be collected using various methods.

For instance, the data pertinent to the execution of the task may be collected using a call center agent such as in the embodiment disclosed in FIG. 2.

Alternatively, the data pertinent to the execution of the task may be collected using an email sent to each of the plurality of parties interacting with an agent 14.

In another embodiment, the data pertinent to the execution of the task may be collected using a SMS message sent to each of the plurality of parties interacting with an agent 14.

In another embodiment, the data pertinent to the execution of the task may be collected using a face to face survey.

In another embodiment, the data pertinent to the execution of the task may be collected using a mystery shopping, i.e. using a person who pretends to be a customer in order to evaluate the work of an employee, a team or a department.

In alternative embodiments, the data pertinent to the execution of the task may be collected using a connection to a website displaying a survey, a telephone audit, an automated phone survey, a mobile kiosk comprising touch screen displays, voicemails or the like.

In a preferred embodiment, a plurality of call center agents is used. Each agent of the plurality of call center agents call each party interacting with an agent of the plurality of parties interacting with an agent with a survey which comprises the generated list of requests. Upon completion of the survey, and according to step 96, the database is automatically populated with the data collected. Still in a preferred embodiment, a mechanism for handling serious issues is further implemented for handling serious issues that are detected during the completion of the survey. In such case, a report is immediately provided to the task managing unit 10. The report is preferably provided using an email and/or through a menu on the database querying interface. The skilled addressee will appreciate that this is of great advantage since it enables the task managing unit to act quickly upon detection of a problem or a very unsatisfied customer. This is of great advantage especially in the case of volatile markets in which it is easy to lose a customer.

According to step 98, the database is accessed.

In one embodiment, the database is accessed by the task managing unit using a database interface provided to the task managing unit. The database interface may be fully customized according to the needs of the task managing unit. It will be appreciated that the database may be accessed at any time by the task managing unit. Real-time data (i.e. current data) as well as historical data may therefore be accessed by the task managing unit.

Moreover, it will be appreciated that the access may be customized to enable specific access rights to specific users at the task managing unit.

For instance, the access to data may be customized for each user of a group of users at the task managing unit using corresponding logins, company ID and passwords for each of the users. It will be appreciated that this is of great advantage in the case where the task managing unit is a large entity in which some users are allowed to access some specific information while some other users are allowed to access other specific information. This therefore enables a control of the dissemination of the information at the task managing unit. The skilled addressee will appreciate that various other methods may be used for authenticating a user accessing the database interface. For instance an RSA token may be used as password in an alternative embodiment.

In a preferred embodiment, a user at the task managing unit logs into the database and accesses a window displaying current and or live data. The user may further browse historical data.

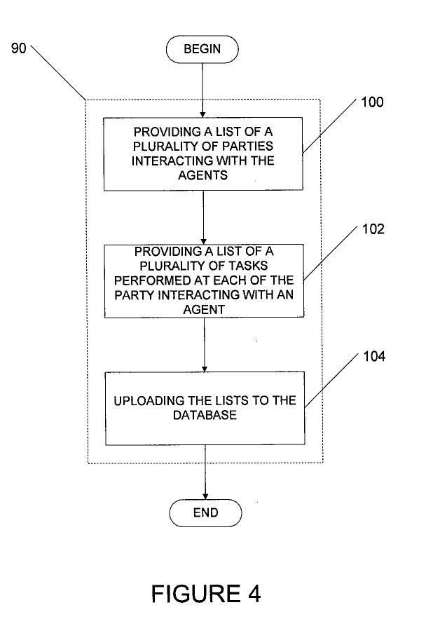

Now referring to FIG. 4, there is shown one embodiment for identifying information pertinent to the execution of a task.

According to step 100, a list of a plurality of parties interacting with the agents is provided.

In one embodiment, the task managing unit 10 provides the list of all parties interacting with an agent executing a task at a given time period.

The list may further comprise general information data such as the name and language of the party interacting with an agent, date, account number of the party interacting with the agent, telephone number and address of the party interacting with an agent, geographic region of the party interacting with an agent, information concerning the product or service delivered to the party interacting with an agent.

According to step 102, a list of a plurality of tasks performed at each of the parties interacting with an agent is provided.

The list may further comprise information concerning the product or service delivered to the party interacting with an agent, a description of the problem to solve, company specific data and technician/sub-contractor specific information data such as name of the agent executing the task, an identification of the agent executing the task, company of the agent executing the task, etc.

According to step 104, the lists are uploaded to the database.

In one embodiment, the lists are uploaded by the task managing unit 10 to the database 44. It will be appreciated by the skilled addressee that the uploading may be performed directly in the database or it may be performed using an uploading interface, not shown in the figures. Alternatively, a file containing the data is sent to the system for enabling a task managing unit to manage the execution of a task using email for instance. In such case the database may be updated manually using the data sent.

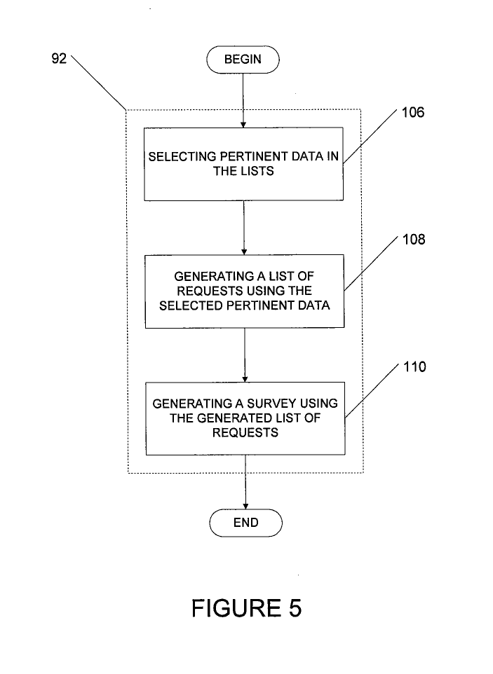

Now referring to FIG. 5, there is shown how a list of requests related to the identified information is generated according to one embodiment.

According to step 106, pertinent data is selected in the lists. In one embodiment, the pertinent data is selected automatically while in another embodiment, the pertinent data is selected manually. The pertinent data is selected by the data collection management unit.

According to step 108, a list of requests is generated using the selected pertinent data. In one embodiment, the list of requests is generated depending on the objectives of the task managing unit.

According to step 110, a survey is generated using the generated list of requests. In one embodiment the survey is generated by the data collection management unit of the system for enabling a task managing unit to manage the execution of a task.

In one embodiment, the survey in saved in the database.

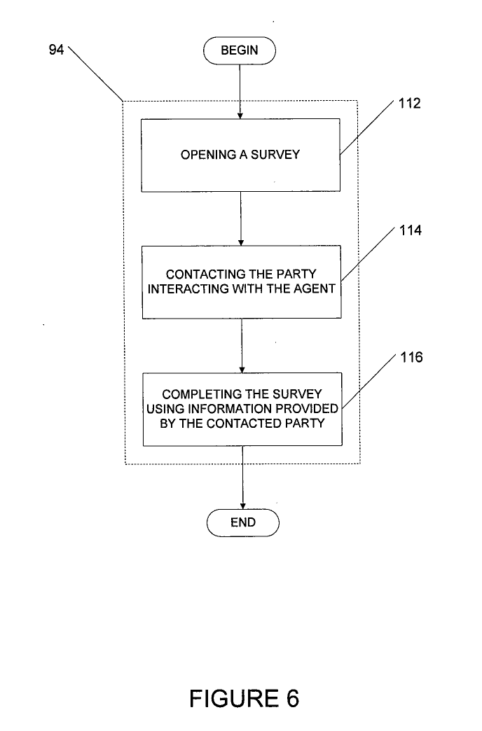

Now referring to FIG. 6, there is shown one embodiment for collecting data pertinent to the execution of the task.

According to step 112, a survey is opened. In this embodiment, the survey is retrieved from the database and is provided to a given data collection unit.

According to step 114, the party interacting with the agent is contacted.

The skilled addressee will appreciate that in one embodiment the party interacting with the agent is contacted by the given data collection unit.

According to step 116, the survey is completed using information provided by the contacted party.

In one embodiment, the survey is completed using information provided by the contacted party using the data collection unit.

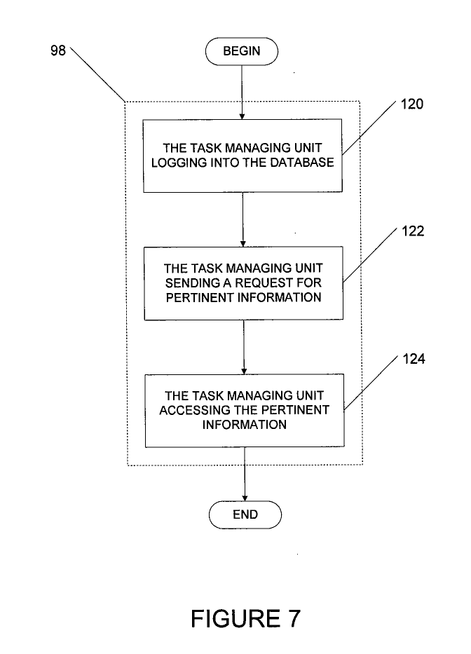

Now referring to FIG. 7, there is shown one embodiment for accessing the database.

According to step 120, the task managing unit is logging into the database.

More precisely and as explained earlier, a user of the task managing unit provides is logging into the database using a login, their company ID and a corresponding password. The skilled addressee will appreciate that various other methods may be used for authenticating a user logging into the database. For instance an RSA token may be used as password in an alternative embodiment.

According to step 122, the task managing unit is sending a request for pertinent information.

In one embodiment, the request for pertinent information is made using a window displayed on a database querying interface.

According to step 124, the task managing unit is accessing the pertinent information. Still in this embodiment, the pertinent information is accessed via the database querying interface.

It will be appreciated that the pertinent information may be displayed using various strategies. As explained above, current data as well as historical data may be displayed.

Moreover, at least one of the pertinent information may be formatted and displayed using for instance an area graph, a bar chart, a pie chart, a circle graph, a line, a curve, a table or the like. It will be further appreciated that the pertinent information may be processed prior being displayed. The processing may comprise performing statistical operations. Moreover, it should be understood by the skilled addressee that the pertinent information may be exported as is or converted into another format, such as Excel format, etc. The pertinent information may also be saved in a processing unit of the task managing unit 10 for future use or viewing.

The skilled addressee will appreciate that the method disclosed is of great advantage since it enables the task managing unit to efficiently manage tasks performed by a plurality of agents executing a task. Moreover, this method enables to quickly identify problems linked to the execution of the task without monopolizing the resources of the task managing unit. The skilled addressee will further appreciate that this is of great advantage in order to adjust a compensation for the plurality of agents executing a task.

Moreover, it will be appreciated that in the case where the system for enabling a task managing unit to manage the execution of a task is implemented by a third party, very few resources needs to be allocated for the management of the task.

In such case and as explained below, various options may be used to charge the task managing unit for the service provided.

Although the above description relates to a specific preferred embodiment as presently contemplated by the inventor, it will be understood that the invention in its broad aspect includes mechanical and functional equivalents of the elements described herein.

1. A method for enabling a company to manage the execution of a task, the method comprising:
identifying information pertinent to the execution of the task;
generating a list of requests related to the identified information;
collecting data pertinent to the execution of the task using the generated list of requests;
populating a database using the collected data; and
providing an interface to the company for accessing the database while the database is being populated to thereby timely manage the execution of the task.

2. The method as claimed in claim 1, wherein said interface is provided to said company by a third party for a fee.

3. The method as claimed in claim 1, wherein the execution of the task is performed by one of a subcontractor and an employee of the company.

4. The method as claimed in claim 1, wherein said identifying of information pertinent to the execution of the task comprises providing a list of a plurality of parties interacting with agents executing the task, providing a list of a plurality of tasks performed by said agents and uploading said list of said plurality of parties interacting with said agents executing the task and said list of said plurality of tasks performed.

5. The method as claimed in claim 4, wherein said generating of said list of requests comprises selecting pertinent data in said uploaded lists, generating a list of requests using said selected pertinent data and generating a survey using said generated list of requests.

6. The method as claimed in claim 5, wherein said collecting of said data pertinent to the execution of the task comprises opening said generated survey, contacting at least one party interacting with said agents, completing said generated survey using information provided by said contacted at least one party and saving said completed survey.

7. The method as claimed in claim 6, wherein said contacting of said at least one party interacting with said agents is performed using at least one of a call center agent, an email, a SMS message, a mystery shopping, a connection to a website, a telephone audit, a mobile quiosk and an automated phone survey.

8. The method as claimed in claim 6, further comprising detecting a serious issue during said collecting of said data pertinent to the execution of the task and reporting said serious issue to said company.

9. The method as claimed in claim 8, wherein said reporting comprises sending an email to said company.

10. The method as claimed in claim 8, wherein a fee is charged for reporting said serious issue to said company.

11. The method as claimed in claim 1, wherein said providing of said interface comprises sending a request for pertinent information in said database using said interface, receiving said pertinent information and displaying said pertinent information in said interface.

12. The method as claimed 11, wherein said pertinent information comprises at least one of current data and historical data.

13. The method as claimed in claim 11, wherein said displaying of said pertinent data is performed using at least one of an area graph, a bar chart, a pie chart, a circle graph, a line, a curve and a table.

14. The method as claimed in claim 11, wherein said pertinent data may be further processed prior said displaying.

15. The method as claimed in claim 14, wherein said processing comprises performing a statistical operation.

16. The method as claimed in claim 1, wherein the providing of an interface comprises logging into a database and displaying an interface upon successful login.

17. The method as claimed in claim 16, wherein said logging is performed via a data network.

18. The method as claimed in claim 17, wherein said data network comprises at least one of a local area network (LAN), a metropolitan area network (MAN), a wide area network (WAN) and a dedicated point to point connection.

19. The method as claimed in claim 18, wherein said data network comprises the Internet.

20. A method of doing business wherein a third party enables a company to manage the execution of a task, the method comprising:
identifying information pertinent to the execution of the task;
generating a list of requests related to the identified information;
the third party collecting data pertinent to the execution of the task using the generated list of requests;
populating a database using the collected data; and
the third party providing an interface to the company for a fee for accessing the database while the database is being populated to thereby timely manage the execution of the task.

21. The method as claimed in claim 20, wherein said populating of said database is performed by said third party.

22. The method as claimed in claim 20, wherein said generating of said list of requests is performed by said third party.

23. The method as claimed in claim 20, wherein said identifying of said information pertinent to the execution of the task is performed by one of said company and said third party.

24. A method for enabling a company to manage the execution of a task, the method comprising:
identifying information pertinent to the execution of the task;
generating a list of requests related to the identified information;
collecting data pertinent to the execution of the task using the generated list of requests;
populating a database using the collected data; and
the company accessing the database while the database is being populated using an interface to thereby timely manage the execution of the task.
